(19) United States
(12) Patent Application Publication
(10) Pub. No.: US 2008/0126385 A1
(43) Pub. Date: May 29, 2008

(54) INTELLIGENT BATCHING OF ELECTRONIC DATA INTERCHANGE MESSAGES

(75) Inventors: Suraj Gaurav, Issaquah, WA (US); Prashant Subrahmanyam Kudli, Redmond, WA (US); Surendra Machiraju, Issaquah, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/533,227

(22) Filed: Sep. 19, 2006

(51) Int. Cl. G06F 17/30

(52) U.S. Cl. 707/102; 707/E17.044

(57) ABSTRACT

Intelligent batching of electronic data interchange (EDI) messages is provided, including in-memory index-based batch membership evaluation. A robust batching subsystem batches EDI transaction sets together in an interchange according to destination partner specific settings. Each partner can have their own criteria to determine which transaction sets should be batched, wherein each criterion can be represented as a Boolean filter expression. The invention efficiently evaluates the batch filter expressions by making intelligent use of commonality in various batch filter expressions when evaluating them. EDI messages are evaluated for membership to batches against at least one in-memory data structure derived from the batch filter expressions, such as a hash table or Dictionary or SortedList, to determine the batches to which an EDI message belongs.

### TECHNICAL FIELD

The subject invention relates to intelligent batching of electronic data interchange (EDI) messages, including, but not limited to, in-memory index-based batch membership evaluation of EDI messages.

### BACKGROUND

Traditionally, with EDI, organizations have been empowered to send virtually limitless kinds of structured messages to one another to facilitate the communication of any kind of business data from one organization to another in automated ways. In this regard, once setup properly, EDI messages can be used to automate a variety of communications to and from partners, business sub-units, buyers, etc., thereby substantially reducing the overhead associated with filling out paper forms, storing volumes of papers, etc. With EDI, for instance, an organization merely fills out an electronic form in a manner conforming to a pre-defined schema, and then the messaging, storage/record keeping and validation of the message(s) associated with the electronic form occurs automatically.

In current EDI messaging scenarios, which applies to both inbound messages (i.e., where a message is received by an organization) and to outbound messages (i.e., where a message is transmitted from an organization to an intended recipient of the message), a single message can be addressed for multiple parties, and multiple messages can be received from different parties. For instance, many hundreds or thousands of messages may be generated for transmission, or received from various parties, at any given time across an organization. Thus, for a variety of reasons, it would be desirable to batch messages created or received by an organization, e.g., create a batch for all messages intended for the same party, create a batch for all purchase orders received, etc., prior to processing or transmitting the messages. Such bulk transaction processing leads to efficiency in storage, transmission and processing times for the messages as compared to simply sending, or receiving, each individual message one at a time.

FIG. 11 shows a hypothetical example of a set of messages 1100, e.g., messages 1100a, 1100b, 1100c, 1100d, 1100e, . . . , 1100N, ready for outbound transmission to a plurality of partners 1110A, 1110B, 1110C, 1110D, 1110E, . . . , 1110NN, where N is the number of messages 1100 and NN is the number of partners to which the messages 1100 may be addressed. In this respect, it can be appreciated that any plurality of messages 1100 may be included as part of an interchange 1110IC1, which may include one or more individual messages, such as messages 1100b and 1100c.

For instance, an EDI purchase order for a company, whether encoded in a native EDI compact flat file format or as extensible markup language (XML), might simultaneously be intended for a seller of the relevant product, a seller of a related product, a shipper of the product, and to an accounting division of the company. This might be represented in FIG. 11, for example, where message 1100a is intended for partners 1110A, 1110B, 1110D & 11NN. Currently, today, four messages are generated to accommodate sending the message 1100a to each of the four partners 1110A, 1110B, 1110D & 11NN.

Similarly, messages 1100b and 1100c of interchange 1110IC1 may be intended for partners 1110A and 1119C, and 1110B, 1110E and 1110NN creating, respectively, two and three messages. Further, message 1100d may be intended for partners 1110B, 1110D and 1110E, generating three messages. Similarly, message 1100e generated by the company may only be intended for partner 1110B. And so on until the Nth message 1100N is generated as intended for partners 1110B and 1110E. In total, to send the six messages today, 15 messages are generated and transmitted through one or more network(s) 1120 to the intended trading partners. While this scenario may be workable to some extent for a mere 15 messages, where N is a number in the hundreds, thousands, or millions, the benefits of batching messages prior to transmission can be appreciated.

Today, however, there is no pre-existing batching capability in EDI systems. To implement batching today, as shown in FIG. 12, a programmer must intervene and design custom batching code 1200 that executes, via a database server 1210 such as a structured query language (SQL) server, custom filtering strategies against EDI messages 1202 stored in a relational database 1220 in order to achieve the desired message batches 1204. For instance, custom batching code 1200 may operate to determine batch membership for messages 1202 according to same addressee, same type of form, or other common characteristic of the messages 1202 that can be extracted from database 1220. Via custom batching code 1200, a particular set of desired custom batches 1204 for EDI messages are then sent to network(s) 1120 to the appropriate addressees.

A first downside with custom batching code 1200 is that, by its nature, it must be custom designed, which is expensive with no guarantees, and even where custom batching code is implemented correctly, it is non-flexible/non-generalizable since custom code 1200 solves only organizational specific batching objectives. Another downside is that if more than a trivial number of messages require filtering, or if more than a trivial number of query expressions against database 1220 are required to satisfy the batching criteria of custom batching code 1200, the input/output (I/O) disk access time associated with accessing the relational database 1220 can become quite significant, even prohibitive, in terms of processing delay.

Accordingly, in consideration of the inefficiency of the state of current transmission and reception of large numbers of messages in an EDI communications system among a plurality of partners, efficient batching of EDI messages is desired that can flexibly be applied to the generation or reception of such EDI messages in the EDI communications system. These and other deficiencies in the state of the art of EDI messaging will become apparent upon description of the various exemplary non-limiting embodiments of the invention set forth in more detail below.

### SUMMARY

In consideration of the foregoing, the invention provides intelligent batching of electronic data interchange (EDI) messages, including in-memory index-based batch membership evaluation of EDI messages. In an exemplary non-limiting embodiment, EDI systems are provisioned with a robust batching subsystem that is used to batch EDI transaction sets together in an interchange. Batching can be performed by the subsystem according to destination partner specific settings. Each partner can have their own criteria to determine which transaction sets should be batched, wherein each criterion can be represented as a Boolean expression. The invention efficiently evaluates the filter expressions by making intelligent use of commonality in various filter expressions when evaluating them.

In various non-limiting embodiments, the invention evaluates EDI messages for membership to batches defined by batch criteria. EDI messages are evaluated for at least one property against at least one in-memory data structure, such as a hash table or a Dictionary, generated based on filter expressions representing the batch criteria. Based on the result of the evaluation, it is determining to which of the batches the EDI message belongs.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the invention in a simplified form as a prelude to the more detailed description that follows.

### BRIEF DESCRIPTION OF THE DRAWINGS

The system and methods for batching EDI messages in accordance with the present invention are further described with reference to the accompanying drawings in which:

FIG. 1 is an exemplary non-limiting block diagram showing techniques for batch membership evaluation in accordance with the invention;

FIG. 2 illustrates an exemplary non-limiting representation of a set of filter expressions including expressions and clauses in accordance with the invention;

FIG. 3 is an exemplary, non-limiting user interface for defining batch filter expressions in accordance with the invention;

FIG. 4 is an exemplary non-limiting block diagram showing benefit(s) of batch membership evaluation in accordance with the invention;

FIG. 5 is an exemplary non-limiting block/flow diagram illustrating marking of batches in accordance with various embodiments of the batch membership evaluation of the invention;

FIG. 6 is an exemplary non-limiting flow diagram illustrating further aspects of evaluating batch membership of EDI messages in accordance with the invention;

FIG. 7 is an exemplary non-limiting flow diagram illustrating further aspects of the generation of auxiliary, in-memory data structures for more efficient evaluation of batch membership of EDI messages in accordance with the invention;

FIG. 8 is an exemplary block diagram of a representative EDI communications system between a home organization having a server and the trading partners of the home organization;

FIG. 9 is an exemplary block diagram of a representative EDI system including a hub and spoke architecture;

FIG. 10 is an exemplary block diagram representative of an interchange data structure including a plurality of EDI transactions;

FIG. 11 is an exemplary block diagram of an EDI messaging scenario without batching of the invention;

FIG. 12 is an exemplary block diagram showing the implementation of custom, inflexible batching code in connection with a relational database with relatively high disk access times;

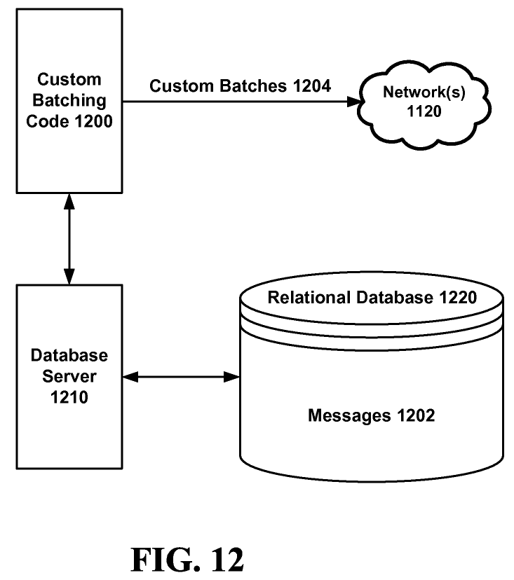

FIG. 13 is a block diagram representing an exemplary non-limiting networked environment in which the present invention may be implemented; and

FIG. 14 is a block diagram representing an exemplary non-limiting computing system or operating environment in which the present invention may be implemented.

### DETAILED DESCRIPTION

### Overview

In consideration of the lack of batching capabilities for messages in today's EDI communications systems, in various non-limiting embodiments, the invention provides systems and methods for batching EDI messages, including, but not limited to, in-memory index-based batch membership evaluation of EDI messages.

In various non-limiting embodiments described herein, a robust batching subsystem is provided that batches EDI transaction sets together in an interchange. Batching is performed according to destination partner specific settings and each partner can have their own criteria to determine which transaction sets should be batched. Since complex and time consuming processing may be implicated over numerous partners and filter expressions, the invention efficiently evaluates the filter expressions.

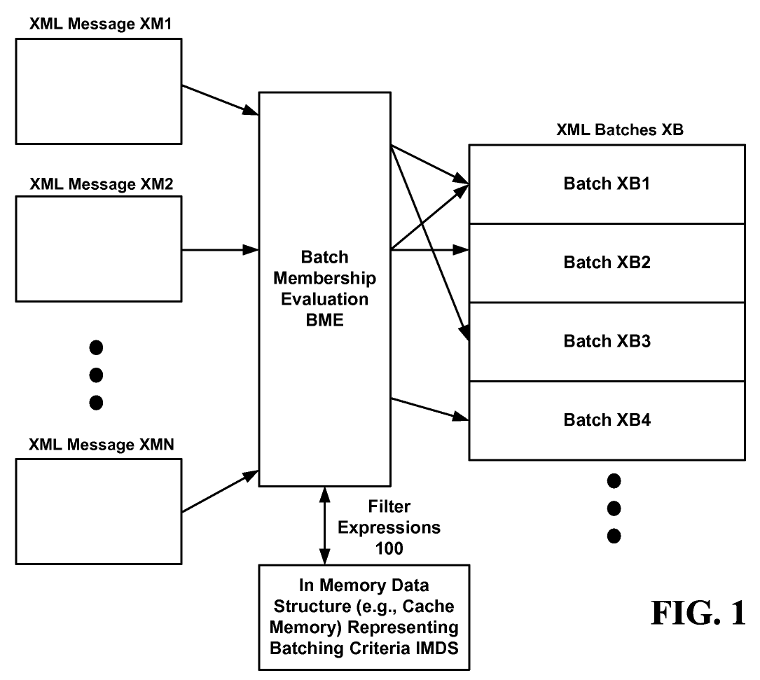

As shown in FIG. 1, EDI messages represented as XML documents XM1, XM2, . . . , XMN are evaluated as they are received by a batch membership evaluation component or object BME provided in accordance with the invention, which evaluates messages XM1, XM2, . . . , XMN against filtering criteria represented in-memory data store IMDS. Filter Expressions 100 can be specified via a user interface (UI) which are then stored in in-memory data store IMDS so that messages can be evaluated for membership to one or more of batches XB1, XB2, XB3, XB4, etc., quickly and efficiently according to techniques described below in more detail in connection with the various embodiments of the invention. The techniques for batching EDI messages can be applied to inbound or outbound messages, for any scenario where the benefits of batching EDI messages can be realized.

It can be appreciated that representations of EDI messages are typically either EDI flat file representations, which represents the structure of an EDI document in a compact, but somewhat difficult to read, manner, or XML representations, which tend to be longer, but more easily read by comparison. In this regard, EDI flat file representations can be converted to XML representations of the EDI flat file representations, and vice versa, according to known conversion mechanisms. Accordingly, wherever an EDI message is referred to herein, such EDI message could be an XML representation or a traditional EDI flat file representation. Additionally, conversions of EDI documents to and from other native storage formats, such as SQL data structures, are also known. Thus, the techniques of the invention are not to be considered limited to any particular representation of an EDI message or document, and conversions can be applied to any EDI message to adhere to any desired format in connection with the various embodiments described herein.

### In-Memory Batch Membership Evaluation of EDI Messages

As mentioned, in various embodiments, the invention is directed to intelligent batching of electronic data interchange (EDI) messages, including in-memory index-based batch membership evaluation of EDI messages to determine to which batches the EDI messages belong. Once a collection of EDI messages is determined for a batch, an interchange including the collection of EDI messages is generated.

In an exemplary non-limiting embodiment, business communications server software, such as Microsoft's BizTalk, includes a robust batching subsystem that is used to batch EDI transaction sets together in an interchange. Batching is performed according to destination partner specific settings. Each partner can have their own criteria to determine which transaction sets need to be batched, wherein each criterion can be represented as a Boolean expression. A given message may be batched for multiple parties. Since for modern business relationships, filter expressions vary linearly with the number of partners, potentially numbering in the thousands, the invention efficiently evaluates the filter expressions.

The filter evaluation mechanism makes intelligent use of commonality in various filter expressions to evaluate them more efficiently. In this regard, under exemplary batching conditions, the performance of the invention was observed to be a vast improvement (e.g., greater than a factor of 50) over custom batching code operating against a relational database as described in the background. These performance gains in turn enable numerous transaction sets to be routed to their batches in a much more efficient fashion, as the batching subsystem efficiently evaluates batch membership according to the techniques of the invention.

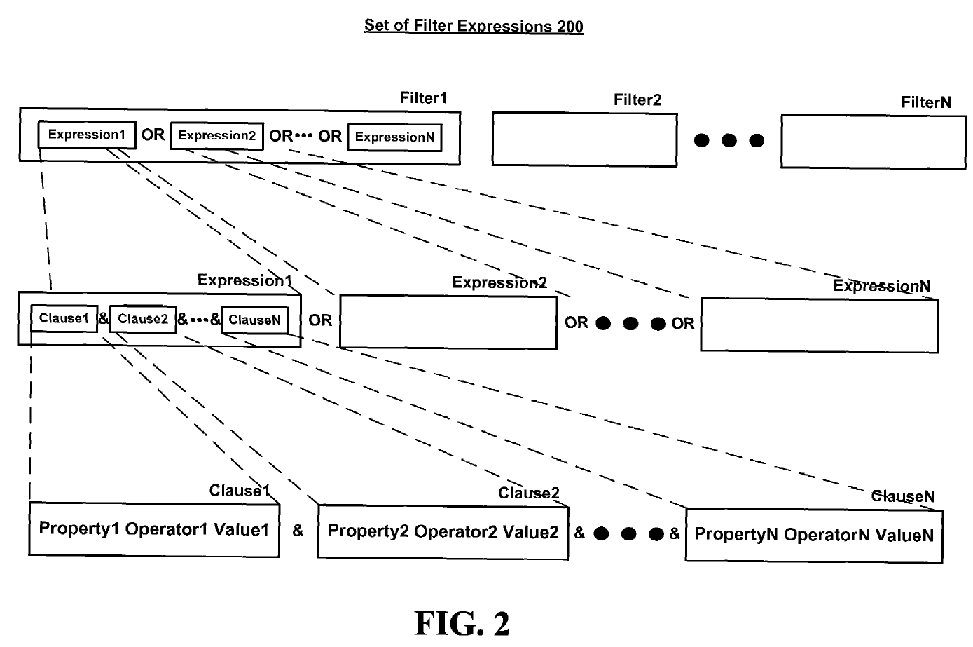

In accordance with the invention, an EDI party defines a set of batching filter expressions, which determine the messages that will be batched for that party. As shown in FIG. 2, a set of batching filter expressions 200 includes a plurality of filter expressions filter1, filter2, . . . , filterN. In one non-limiting embodiment, there is one filter expression per trading partner. The basic units of storage for a batching filter expression, such as filter1, in accordance with the invention are ‘clauses,’ such as clause1, clause2, . . . , clauseN. As shown, one or more clauses clause1, clause2, . . . , clauseN make up an ‘expression,’ such as expression1. Clauses in an expression are AND'ed together from a Boolean logic standpoint. In turn, multiple expressions expression1, expression2, . . . , expression N are OR'ed together from a Boolean logic standpoint to make up the batching filter expression filter1. For the avoidance of doubt, N can be a different number for each of the clauses, expressions and filters.

A filter expression can thus be defined as follows.

Filter->Expression1 OR Expression2 . . . .

Expression->Clause1 AND Clause2 . . .

Clause->PropertyName Operator Value

In more detail, a clause consists of the property name, namespace and value at the minimum. A clause may also hold the predicate value type and the comparison operator type. In this respect, in a non-limiting implementation, this defines the minimum set of values that can form a filter expression, which is not empty. In another non-limiting implementation, a clause implements the IComparable interface so that any two clauses can be compared and can be inserted into a sorted list.

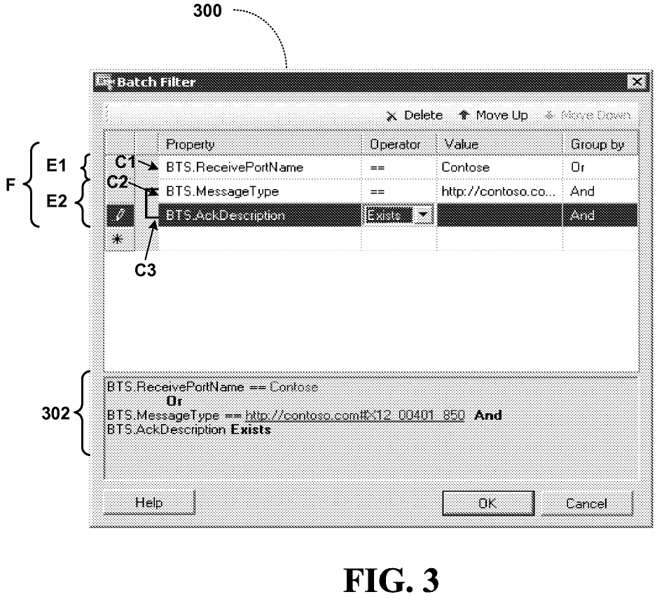

A screenshot of a filter expression is as shown in user interface (UI) 300 of FIG. 3. The filter expression F represented in FIG. 3 includes two expressions E1 and E2 that are OR'ed together, whereby expression E1 includes only clause C1 and expression E2 includes two clauses C2 and C3 AND'ed together. A single filter expression F is represented in UI 300 because as mentioned, in one embodiment, there is one filter expression per party. FIG. 3 also includes a more readable script form 302 of the filter expression for a more intuitive description of the filter expression F.

There could be thousands of parties, and thus UI 300 can in turn be used to define a filter expression for other parties as well. For each EDI message to be batched, therefore, the filter expressions for all parties are evaluated to determine which parties are interested in the message. In this regard, for efficiency of such evaluation, the filter engine provided for an EDI Batching subsystem in accordance with the invention makes intelligent use of the fact that even though there could be thousands of filter expressions, there are only a handful of properties, which are commonly tested by the filter expressions. Additionally, the filter engine of the invention takes into account that some of the operators, such as the “equals” and “exists” operator are utilized when batching according to filter expressions more frequently than others. By taking such knowledge about the filter expressions into consideration, the algorithms of the invention provide performance improvements over the state of the art.

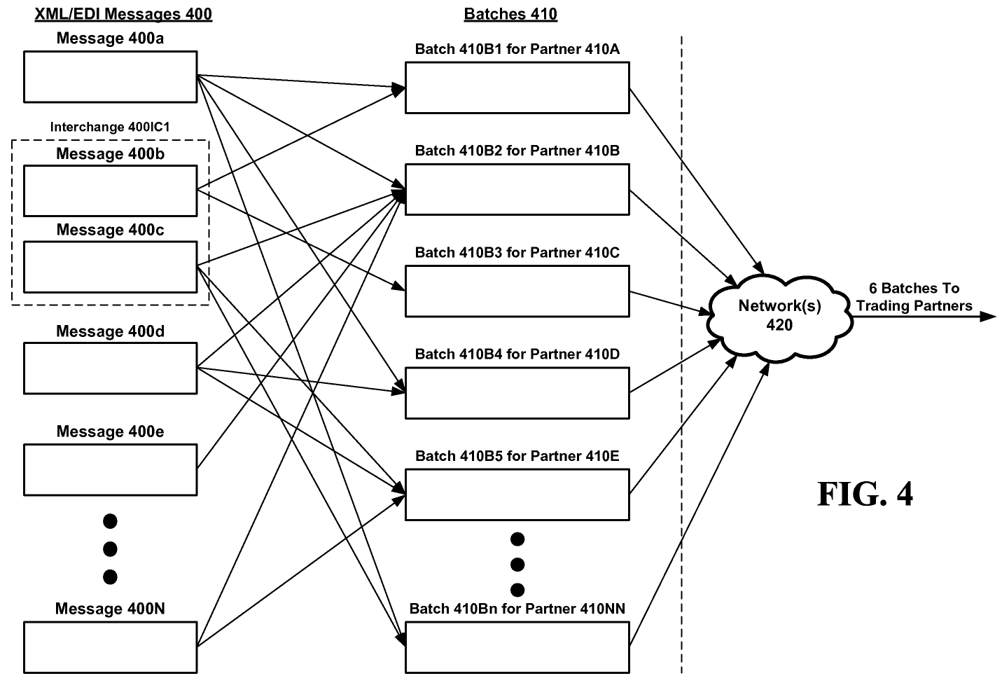

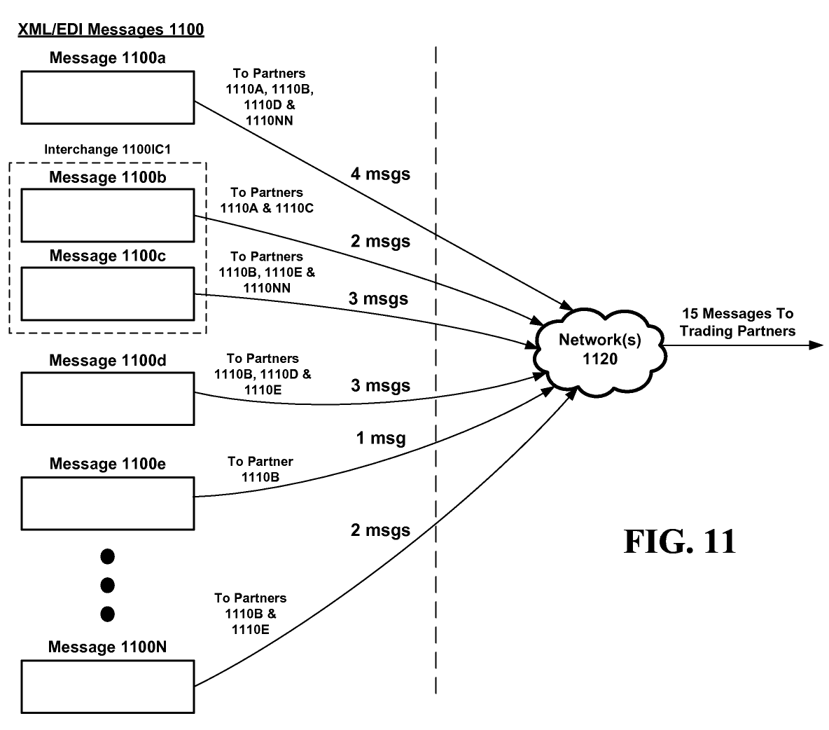

FIG. 4 illustrates the benefits of the use of the batching subsystem provided in accordance with the invention as compared to FIG. 11, without batching. As shown, instead of the complex morass of individual EDI messages that must be negotiated by EDI systems without the invention, the invention enables fast and efficient evaluation of EDI messages (transaction sets) 400 to determine corresponding batches 410 to which the EDI messages belong. More specifically, the batching mechanism of the invention batches the EDI messages 400a, 400b, 400c, 400d, 400e, . . . , 400N to determine to which batches 410B1, 410B2, 410B3, 410B4, 410B5, . . . , 410Bn the EDI messages belong. In the example, the batches are arranged simply according to the partner to whom the message is addressed, but one can imagine a limitless number of filter expressions that can be created to batch messages with the batching subsystem of the invention. After evaluation has occurred, the batches can be transmitted as interchanges to the respective Partners 410A, 410B, 410C, 410D, 410E, . . . , 410NN via network(s) 420. In the example, instead of 15 messages sent as shown in FIG. 11, only 6 batches are transmitted. In this regard, the savings become even clearer as the number of EDI messages becomes quite large, e.g., N>100.

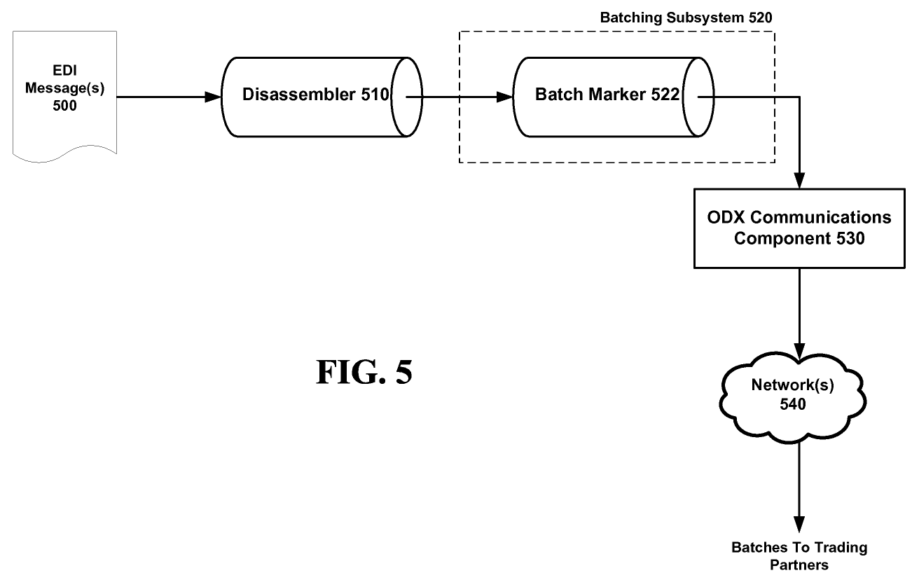

FIG. 5 is a block diagram illustrating an exemplary non-limiting EDI pipeline for receiving EDI messages to be potentially batched according to the invention. In this regard, EDI message(s) 500 are received via disassembler 510, which parses the message, and in one embodiment, transforms the EDI document to an XML representation. Then, the batching subsystem 520 of the invention efficiently evaluates, as described in more detail below, which message(s) are intended for which batch(es). In one embodiment, the batching subsystem 520 includes a batch marker 522 for marking the messages with appropriate batch(es). When a batch is ready for transmission, the batch is transmitted to the appropriate send port, which handles the appropriate transmission of the batch(es) to the appropriate trading partner(s).

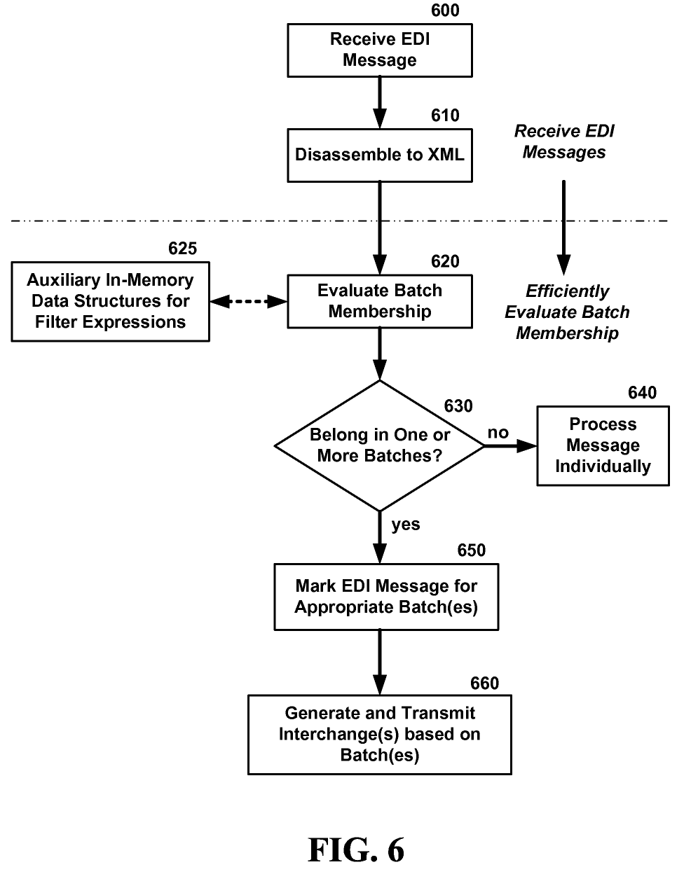

FIG. 6 is a flow diagram showing an exemplary process for batching EDI messages based on filter expressions defined for each party in accordance with the invention. At 600, an EDI message is received which is disassembled to XML at 610. At 620, the message is evaluated for its batch membership(s), while consulting auxiliary in-memory data structures 625 generated from the filter expressions for all parties. At 630, if the message does not belong in any batches as determined at step 620, then the message is processed as normal without batching the message at 640, i.e., as if the batching subsystem of the invention were not provided. If, however, at 630, it is determined that the message belongs with one or more batches, then at 650, the message is marked appropriately so that at 660, the appropriate batches can be formed as interchange documents ready for transmission to the respective partners.

In an exemplary non-limiting implementation of the above-described batching subsystem and processes, for use in connection with batching a Property Filter Store is constructed by going over each party's filter expression. For instance, a filter expression might be of the following form:

```
<Filter>
  <Group>
    <Statement> [Property =] [Operator =] [Value =] </Statement>
    <Statement> </Statement>
  </Group>
    ...................
  <Group> </Group>
</Filter>
```

In this form, each Group corresponds to an Expression class as discussed above. Similarly, each statement within a Group corresponds to the Clause class, which is the basic unit of filter storage discussed above. As observed from the above form of filter expression, all the statements (Clauses) belong to a single Group (Expression) and all of them have to be satisfied to satisfy the Filter (AND condition). In this respect, if any of the Group (Expression) is satisfied, then Filter is satisfied.

More particularly, the different operators that may be supported in statements, or Clauses, defined in accordance with the invention are: (1) Equality (==), (2) InEquality (!=), (3) GreaterThan (>), (4) GreaterThanOrEquals (>=), (5) LessThan (<), (6) LessThanOrEquals (<=), (7) Exists and (8) BitwiseAnd. In exemplary non-limiting embodiments of the invention, auxiliary structures are generated for use during filter evaluation, which is described in more detail below. The auxiliary structures can be generated in-memory, such as cache memory for fast and efficient evaluation.

In one non-limiting embodiment of the invention, a filter property store is constructed that includes a dictionary for each of the operators that can be used in a filter expression, except the BitwiseAnd operator. For additional efficiency, a dictionary is constructed for the Equality and Exists operators, which includes a list containing the clauses for these two operators. For the operators from (3) to (6) above in the previous paragraph, a dictionary is constructed which is a sorted List of Clauses for each key. The sorted List is utilized to traverse a range of values during filter evaluation. For the Inequality operator, a dictionary is constructed containing an array list of Clauses for a particular key. This is because, for an inequality operator, the entire list will likely be traversed anyways.

In various non-limiting embodiments of the invention, for all the above operators, except the equality operator, the ‘key’ is the Clause name +“#”+ Clause namespace. The filter key for an equality store is the Clause name +“#”+ Clause namespace +“#”+ (Lower case) Clause value string. With the equality operator, a perfect match is desired and thus, with such a key definition, all the values in the dictionary that are hashed to a given key satisfy the equality criterion making for a fast and efficient evaluation. This simple access pattern makes the evaluation for an equality operator very fast. Since it is noted that a high percentage of the operators in a filter will be the equality operator (e.g., is this message addressed to a company name==“Contuso”?), the auxiliary structure for equality enhances performance of batch membership evaluation significantly.

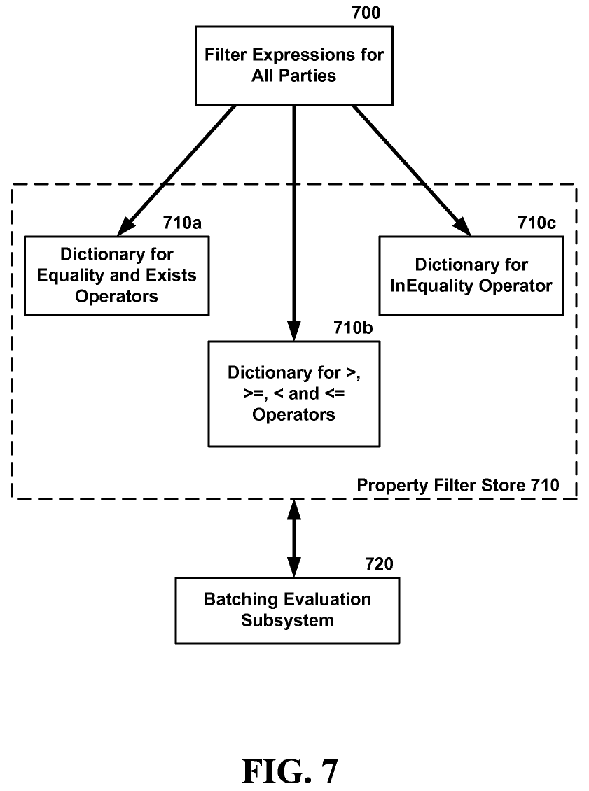

FIG. 7 is an exemplary, non-limiting flow/block diagram illustrating the formation of the property filter store 710 in accordance with the invention. By traversing each of the filters for each of the parties at 700, dictionaries are created based on the operators represented in the filters. This includes a dictionary 710a for the equality and exists operators, a dictionary 710b for the greater than, greater than or equal to, less than, and the less than or equal to logical operators (e.g., one dictionary per operator for each of these operators) and a dictionary 710c for the inequality operator. Using dictionaries 710a, 710b and 710c, which are in-memory data structures, batching evaluation subsystem 720 can quickly evaluate to which batches a given EDI message belongs.

In exemplary detail for a non-limiting implementation of the invention, the Property Filter Store is loaded the first time a subscription evaluation occurs. Then, all the EDI parties that are configured are read to construct the Property Filter Store explained above. A unique filter is thus defined for each set of partyID/EdiMessageType. As mentioned, each group in the filter/group/statement representation described above corresponds to an Expression object. The expression object is linked to the filter by its ParentExpression property. Similarly, the parentexpression of the Clause object links it to its parent expression.

Once they are constructed, the filter is loaded on a separate thread and is switched with the main thread variable once loaded. In one non-limiting embodiment, each filter value, once loaded in memory, is retained until a filter refresh timer elapses. The filter timer may be configurable or based on heuristics.

### Efficient Filter Evaluation

In various exemplary, non-limiting embodiments of the invention, to evaluate a subscription, the context of a message and the type of the message are used. Each promoted property in the context of the message is then used as a key into each of the operator specific dictionaries described above. A Result List is generated after making a pass over all the eight operator stores, as constructed above. In one non-limiting embodiment, the Result List includes a sorted List of Result Sets, which are sorted on PartyIDs. A Result Set includes a list of expressions and their satisfied count.

In one non-limiting implementation, an expression is satisfied when all the different AND clauses in an expression are satisfied. When a Clause is added during evaluation to the Result Set, the satisfied count of the corresponding Expression is incremented. When the satisfaction count reaches the expression's AND count, the expression is deemed satisfied.

In one embodiment, the Result List is obtained for each promoted context property in the message and then, the Result Lists are merged after each pass into a Master Result List having one Result Set per party. Merging either increments the existing AND count until a result Set is satisfied or if it does not already exist, a new Result Set is added to the Master Result List. After iterating over all the promoted properties, a Master Result List is obtained that contains either fully satisfied or partially satisfied Result Sets. Then, the Master Result List can be traversed to obtain the parties that are completely satisfied. These can optionally be further filtered based on whether batching is activated for them and they are within their batching window (Batching Start - - - Batching End window). These options can be based on configuration and accessed through PartnerAgreementManager APIs.

To obtain a Result List from a promoted context property, a pass is taken over each of operator specific filter stores where the keys are generated from the promoted context as described above. For the Equality and Exists operators, the values retrieved based on consulting the associated dictionary can be added directly to the Result List. For the BitwiseAnd operator, the entire list is reviewed to obtain all those that match for addition to the list. Fortunately, this operator is rarely used in practice. For the operators (3) to (6) above, in one implementation of the invention, AddRangeFrom and AddRangeTo methods are used to obtain the range of values. For GreaterThan(>) and GreaterThanOrEquals(>=), the AddRangeToo method is used to get the values up to or equal to the context (or clause) value from the Sorted List of the dictionary. For the LessThan (<) and LessThanOrEquals(<=), the AddRangeFrom( ) method is used to obtain the values from or above the Context value from the Sorted List. For an inequality operator, everything that is not equal to the incoming Clause satisfies the condition. This is the reason an array List is used for the inequality operator instead of a SortedList.

In sum, today's technology evaluates filter expressions at the database layer using a database, such as SQL. However, it is desirable to have the efficient evaluation engine of the invention given the potential complexity of batching filter expressions and number of partners. A performance comparison of today's state of the art utilizing SQL versus in-memory batching membership evaluation in accordance with the invention illustrated the clear benefits of the invention.

In a simulated test on a single thread comprising a message containing 15 properties, with about 2000 parties configured, where 1000 of those parties evaluate to the test message for batching purposes, it took 1125 seconds using today's technology and only 19.5 seconds to evaluate using the techniques of the invention, a gain of 56 times as a factor.

### Supplemental Context Regarding EDI Messaging Systems

EDI is the exchange of structured information, by agreed upon messaging standards, from one computer or computer application to another by electronic means with minimal human intervention. Based on approved formatting standards and schemas, EDI is one of the ways businesses exchange computer-to-computer business information. For example, millions of companies around the world transmit and store data associated with business transactions (e.g., purchase orders, shipping/air bills, invoices, or the like) using EDI to conduct commerce.

EDI may thus be defined as computer-to-computer exchange of business information using ‘approved’ formatting standards, referring to specific interchange methods agreed upon by national or international standards bodies for the transfer of business transaction data. One typical application for EDI messaging is the automated purchase of goods and services, though EDI messages are by no means limited to any particular kind of business data. In this regard, millions of companies around the world use EDI to conduct commerce. In raw format, EDI data is transmitted as delimited files (without self describing tags) and therefore the encoding rules enforce very strict formatting rules to ensure the destination application is able to successfully parse and consume the information for down stream processing.

Organizations that send or receive documents from each other are referred to as “trading partners” in EDI terminology. The trading partners agree on the specific information to be transmitted and how it should be used. Service providers provide global platforms (also known as trading grids) to connect and integrate “business partners” around the world. They provide integration platforms that make the exchange of EDI (or XML) documents transparent and easy between diverse constituents. These providers also track and reconcile documents to reduce errors and improve supply chain performance.

EDI translation software provides the interface between the internal system and the common standards and applies to both “inbound” documents and “outbound” documents. Translation software may also utilize other methods or file formats translated to or from EDI.

It can be appreciated by those of skill in the art that the structured information of EDI files can also be represented with the extensible markup language (XML), and vice versa. Despite the use of EDI being somewhat unheralded relative to its counterpart XML, EDI files are still the data format used in a majority of electronic commerce transactions in the world.

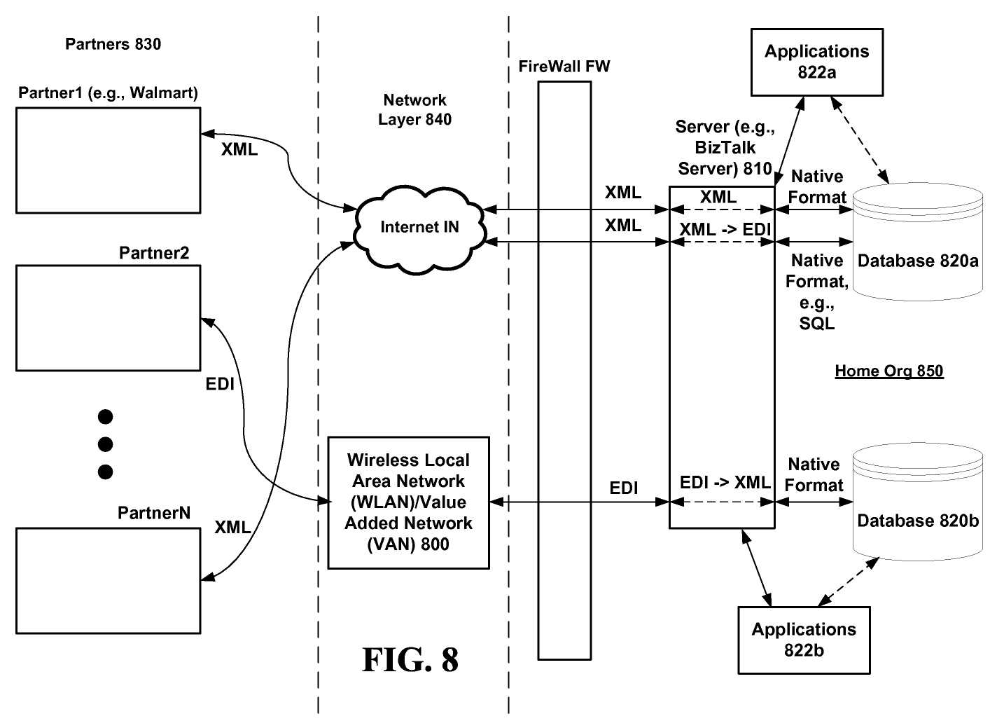

In the exemplary EDI system for a home organization 850 shown in FIG. 8, typically server software, such as Microsoft's BizTalk Server 810 can be deployed to interact outside of the home organization 850 via network layer 840 and to interface with databases 820a, 820b, etc. so that various applications 822a, 822b, etc., can interact with the automated storage of business records received by databases 820a, 820b, etc. EDI files or XML representations of EDI files can be received via Internet IN, or a wireless local area network (WLAN) or value added network (VAN) 800 of network layer 840, e.g., through firewall FW, and such EDI/XML messages can be received from any of a variety of trading partners 830, i.e., partner1, partner2, . . . partnerN. Server 810 can handle any of the necessary conversions and parsing of EDI files or XML representations thereof, and any conversions to or from a native database format, such as SQL.

Typically, when an EDI messages are received, a server receiving the EDI messages can answer in terms of an acknowledgment of receipt of the EDI messages to its trading partner. The server will specify whether the EDI message is invalid according to the schema, and if invalid, will specify why, or the server will specify that the EDI message was accepted, accepted with errors or rejected.

Internet IN has enabled EDI transactions to be transmitted between trading partners in an even more efficient manner. Internet IN provides business and government agencies with an environment that is open, fast, cost effective, and widely accepted and used.

VAN 800 is a mechanism that facilitates the transfer of electronic data between trading partners. A VAN 800 can be thought of as a post office, or a dedicated pipe, that allows an entity to send EDI formatted data to one of their trading partners at any time. The VAN 800 will hold the file of transmitted transactions until the trading partner to whom it is addressed retrieves it at a later time.

The EDI standards were designed to be independent of lower level technologies and can be transmitted using Internet protocols, such as the file transfer protocol (FTP), telnet and email, as well as private networks, such as value-added networks (VANs). EDI documents contain the same data that would normally be found in a paper document used for the same organizational function. For example, an EDI ship-from-warehouse order might be used by a manufacturer to tell a warehouse to ship product(s) to a retailer. It typically has a ship to address, bill to address, a list of product numbers (e.g., a UPC code) and quantities. It may also have other information if the parties agree to include it. However, EDI is not confined to just business data directly related to trade, rather but encompasses all fields such as medicine (patient records, laboratory results, etc.), transport (container and modal information, etc.), engineering and construction, etc., i.e., anywhere a first entity may wish to automate the exchange of data with another entity.

In a typical EDI transaction model, a large business entity or an EDI integration broker trades with numerous partners and has the technical capability to handle numerous EDI transaction data in various EDI formats and schemas. These entities, also known as “hubs,” transact with one or more suppliers, also known as “spokes.” Each of the spokes typically is a relatively small business entity that is only capable of dealing with one hub.

Before the spokes attempt to initiate transactions via EDI with the hub, the hub typically transmits various EDI schemas to the spokes so that the spokes can properly format the EDI transactions according to the EDI schemas.

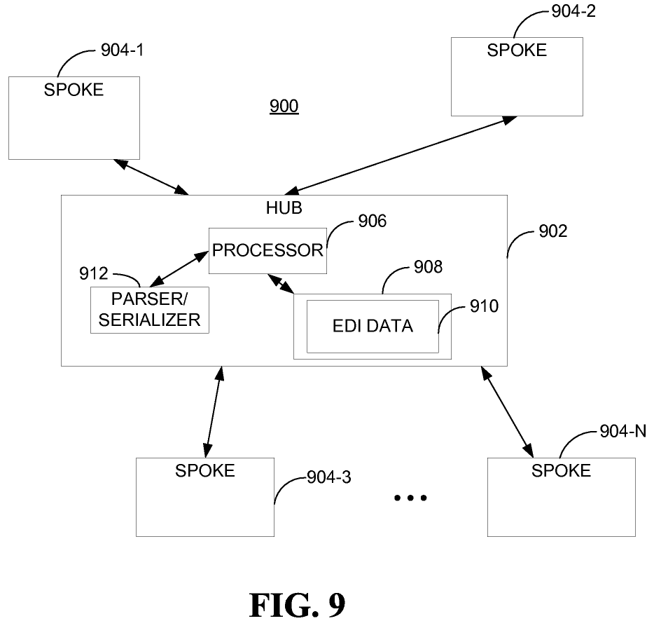

FIG. 9 is a block diagram illustrating a system for conducting EDI transactions according to exemplary non-limiting embodiments of the invention. A system 900 is illustrated for conducting EDI transactions. System 900 includes a hub 902 linked to and communicating with one or more spokes (e.g., spokes 904-1, 904-2, 904-3, . . . , 904-N). In one embodiment, the hub 902 includes a server computer or a computing device serving one or more processors (e.g., processor 906) or processing units for executing computer-executable instructions for serving the spokes 904. In one example, the spokes 904 include a computing device having one or more components included in or coupled with a computer 930, as shown in FIG. 6.

In one example, the hub 902 also includes a memory area 908 for storing one or more EDI schemas, such as an EDI schema 910. Initially, the hub 902 and the spokes 904-1, 904-2, 904-3, . . . , 904-N establish agreements as to the EDI formats or standards to be used for transmitting transaction data therebetween. Once the parties determine the particular EDI formats or standards to use, the hub 902 selects the appropriate EDI schemas to be transmitted to the spokes 904-1, 904-2, 904-3, . . . , 904-N. In another example, the hub 902 may choose to select all EDI schemas for all types of transactions, such as purchase orders, bills of lading, invoices, payrolls, or the like, to the spokes 904-1, 904-2, 904-3, . . . , 904-N.

Although the communications between the hub 902 and the spokes 904-1, 904-2, 904-3, . . . , 904-N can be a private or public communications network, a wired or wireless network, the spokes 904-1, 904-2, 904-3, . . . , 904-N typically lack the hardware resources to handle large amount of EDI schemas sent from the hub 902. In addition, the type and bandwidth of computing network communications for the spokes 904-1, 904-2, 904-3, . . . , 904-N are not equipped to handle such demand imposed by the thousands of EDI schemas, which can reach several Gigabytes in data size.

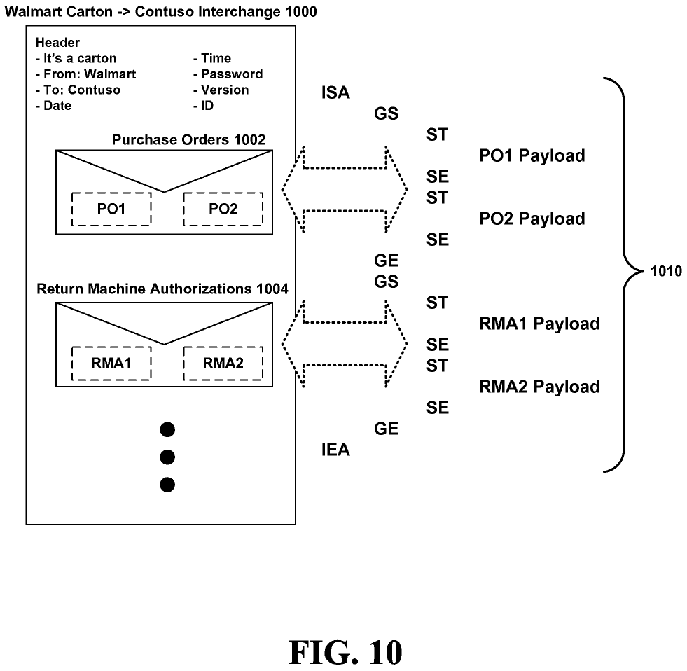

FIG. 10 in turn illustrates that an organization can generate an interchange 1000—a sort of carton for EDI messages—which includes a plurality of EDI messages. Interchange 1000 typically includes a header which includes a type of document, from whom the document originated, to whom the document is addressed, the date, the time, any password information, version information, identification information, and the like. Then the interchange 1000 lists a series of purchase orders 1002 and return machine authorizations (RMAs) 1004, conceptually shown as envelopes in the carton. In turn, each envelope conceptually represents one or more individual EDI files, or messages. For instance, purchase orders 1002 include individual purchase orders PO1 and PO2, and RMAs 1004 include RMAs RMA1 and RMA2, and so on.

In turn, there is a flat file native EDI format that corresponds to this conceptual relationship between carton->envelopes->messages. As illustrated by shell 1010 corresponding to the conceptual representation, the ISA<->IEA indent level represents the beginning and end of the interchange (carton). The GS and GE indent levels represent the beginning and end of any envelopes within the carton, and the ST and SE indent levels represent the beginning and end of any messages within an envelope, i.e., inbetween any ST and SE will be an individual message payload, such as PO1 Payload, PO2 Payload, RMA1 Payload and RMA2 Payload.

There are several advantages of using EDI all of which provide distinct benefits to the user. One of the most notable benefits to using EDI is the time-saving capability it provides. By eliminating the process of distributing hard copies of information throughout the company, easy access to electronic data simplifies inter-department communication. Also, another time-savings advantage is the ability to track the origin of all information therefore significantly reducing time spent on corresponding with the source of the information.

Another benefit for the user of this information system is the ultimate savings in costs for an organization. Although the initial set-up costs may seem high, the overall savings received in the long run ensures its value. For any business, regardless of its size, hard-copy print outs and document shipping costs add up. EDI allows for a paper-less exchange of information reducing handling costs and worker productivity that is involved with the organization of paper documents.

EDI has another strong advantage over paper-based information exchange, which has to do with accuracy of information. When the information is already stored electronically, it speeds up an organizations ability to check for accuracy and make any necessary corrections as the data is already input to the system. Also, unlike paper-based methods, EDI allows for the ability to send and receive information at any time thereby tremendously improving an organizations ability to communicate quickly and efficiently.

A disadvantage of using EDI involves the initial set-up. The preliminary expenses and time that arise from the implementation, customization and training can be costly. However, as EDI systems continue to improve, such as by using the batching membership evaluation techniques of the invention, such disadvantage is disappearing as ease of use increase.

### EDIFACT and X12 Standards for EDI Documents

There are two major sets of EDI standards which can be used to generate and receive/process EDI messages: the United Nations Electronic Data Interchange for Administration, Commerce and Transport, which is a translation of UN/EDIFACT (“EDIFACT”) and the American National Standards Institute's (ANSI) Accredited Standards Committee (ASC) X12 (“X12”). Both used worldwide, X12 tends to be more popular in North America than EDIFACT. These standards prescribe the formats, character sets, and data elements used in the exchange of documents and forms, such as invoices and purchase orders, e.g., purchase orders are called “ORDERS” in EDIFACT and “850s” in X12.

Whichever selected, the standard dictates which pieces of information are mandatory for a particular document, which pieces are optional and gives the rules for the structure of the document. In this regard, with optional pieces, two EDI documents can follow the same standard and contain different sets of information. For example, a food company might indicate a particular product expiration date while a clothing manufacturer might choose to send color and size information.

For illustrative purposes only, the following is an example EDIFACT message, for instance, that might be used to answer to a product availability request:

UNB+IATB:1+6XPPC+LHPPC+940101:0950+1’
UNH+1+PAORES:93:1:IA’
MSG+1:45’
IFT+3+?*XYZCOMPANY AVAILABILITY?*’
ERC+A7V:1:AMD’
IFT+3+NO MORE FLIGHTS'
ODI’
TVL+240493:1000::1220+FRA+JFK+DL+400+C’
PDI++C:3+Y::3+F::1’
APD+74C:0:::6++++++6X’
TVL+240493:1740::2030+JFK+MIA+DL+081+C′
PDI++C:4’
APD+EM2:0:1630::6+++++++DA’
UNT+13+1’
UNZ+1+1’

wherein the following symbols have the following meanings:

′ is a segment terminator;

+ is a data element separator;

: is a component data element separator;

* is a repetition separator; and

? is a release character.

To explain the information contained in some of the above segments, the segment of the above exemplary EDI file designated by “UNH+1+PAORES:93:1:IA′” is the header segment. A header segment is required at the start of every EDI message. With this particular file segment, the message name and version is specified as PAORES 93 revision 1 and it was defined by the organization IATA. The segment of the above exemplary EDI file designated by “IFT+3+NO MORE FLIGHTS′” is an ‘Interactive Free Text’ segment containing the text ‘NO MORE FLIGHTS.’ The segment of the above exemplary EDI file designated by “UNT+13+1′” is the tail segment, whereby it is indicated that the message sent contains 13 segments.

EDIFACT files have a hierarchical structure. The top level element is referred to a message. A message is a sequence of groups and segments. A group or segment can be mandatory (M) or conditional (C) and can be specified to repeat, for example C99 would indicate between 0 and 99 repetitions of a segment or group, whereas M99 would mean between 1 and 99 repetitions.

A group, like a message, is a sequence of segments or groups. The first segment/group beneath a group must be mandatory. If the logic of the situation demands it is conditional, then the group itself should be made conditional instead.

In exemplary practice, where the X12 standard is used, X12 schemas use the following format:

X12 Schemas=X12_{Version}_{TsId},

which indicates that:

1) all X12 schemas have a root node name that starts with X12;

2) “Version” represents the version information of the document, and it is a dynamic piece of information which is configuration or instance driven; and

3) “TsId” stands for “transaction ID” of the document being processed and is read from the input instance.

In exemplary practice, where the EDIFACT standard is used, EDIFACT schemas use the following format:

EDIFACT Schemas=Efact_{Version}_{Tsid},

which indicates that:

1) all EDIFACT schemas have root node name that starts with Efact;

2) “Version” represents the version information of the document, and it is a dynamic piece of information which is configuration or instance driven; and

3) “TsId” stands for “transaction ID” of the document being processed and is read from the input instance.

Accordingly, the root node name can be used to distinguish between X12 and EDIFACT representations of structured information.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with processes for batching EDI transaction sets in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for batching EDI messages in accordance with the invention.

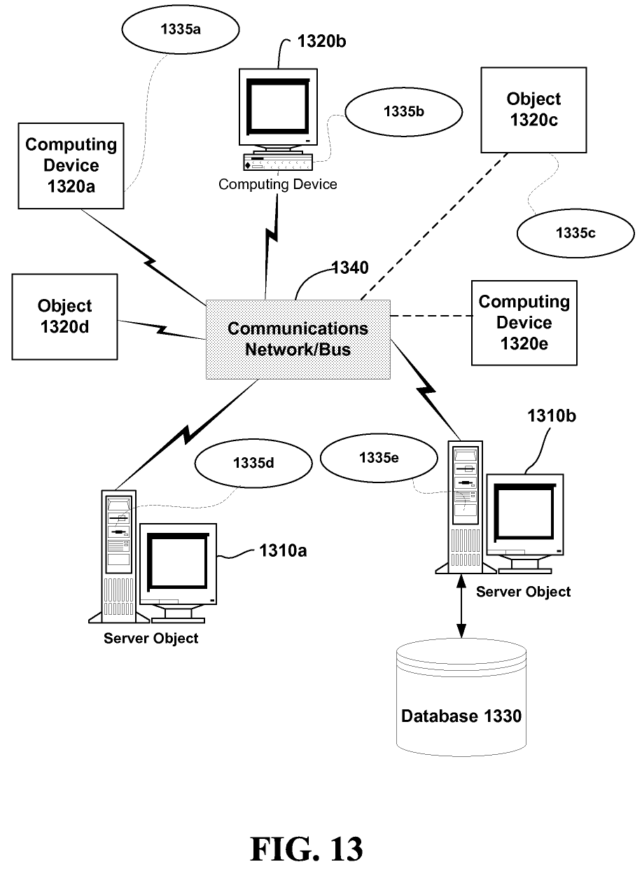

FIG. 13 provides a schematic diagram of an exemplary networked or distributed computing environment. The distributed computing environment comprises computing objects 1310a, 1310b, etc. and computing objects or devices 1320a, 1320b, 1320c, 1320d, 1320e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 1340. This network may itself comprise other computing objects and computing devices that provide services to the system of FIG. 13, and may itself represent multiple interconnected networks. In accordance with an aspect of the invention, each object 1310a, 1310b, etc. or 1320a, 1320b, 1320c, 1320d, 1320e, etc. may contain an application that might make use of an API, or other object, software, firmware and/or hardware, suitable for use with the systems and methods for batching EDI messages in accordance with the invention.

It can also be appreciated that an object, such as 1320c, may be hosted on another computing device 1310a, 1310b, etc. or 1320a, 1320b, 1320c, 1320d, 1320e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to the processes for batching according to the present invention.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 13, as an example, computers 1320a, 1320b, 1320c, 1320d, 1320e, etc. can be thought of as clients and computers 1310a, 1310b, etc. can be thought of as servers where servers 1310a, 1310b, etc. maintain the data that is then replicated to client computers 1320a, 1320b, 1320c, 1320d, 1320e, etc., although any computer can be considered a client, a server, or both, depending on the circumstances. Any of these computing devices may be processing data or requesting services or tasks that may implicate the batching of EDI messages in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for batching EDI messages of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 13 illustrates an exemplary networked or distributed environment, with server(s) in communication with client computer (s) via a network/bus, in which the present invention may be employed. In more detail, a number of servers 1310a, 1310b, etc. are interconnected via a communications network/bus 1340, which may be a LAN, WAN, intranet, GSM network, the Internet, etc., with a number of client or remote computing devices 1320a, 1320b, 1320c, 1320d, 1320e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to generate, transmit or receive EDI messages.

In a network environment in which the communications network/bus 1340 is the Internet, for example, the servers 1310a, 1310b, etc. can be Web servers with which the clients 1320a, 1320b, 1320c, 1320d, 1320e, etc. communicate via any of a number of known protocols such as HTTP. Servers 1310a, 1310b, etc. may also serve as clients 1320a, 1320b, 1320c, 1320d, 1320e, etc., as may be characteristic of a distributed computing environment.

As mentioned, communications may be wired or wireless, or a combination, where appropriate. Client devices 1320a, 1320b, 1320c, 1320d, 1320e, etc. may or may not communicate via communications network/bus 14, and may have independent communications associated therewith. For example, in the case of a TV or VCR, there may or may not be a networked aspect to the control thereof. Each client computer 1320a, 1320b, 1320c, 1320d, 1320e, etc. and server computer 1310a, 1310b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 1310a, 1310b, 1320a, 1320b, 1320c, 1320d, 1320e, etc. may be responsible for the maintenance and updating of a database 1330 or other storage element, such as a database or memory 1330 for storing data processed or saved according to the invention. Thus, the present invention can be utilized in a computer network environment having client computers 1320a, 1320b, 1320c, 1320d, 1320e, etc. that can access and interact with a computer network/bus 1340 and server computers 1310a, 1310b, etc. that may interact with client computers 1320a, 1320b, 1320c, 1320d, 1320e, etc. and other like devices, and databases 1330.

### Exemplary Computing Device

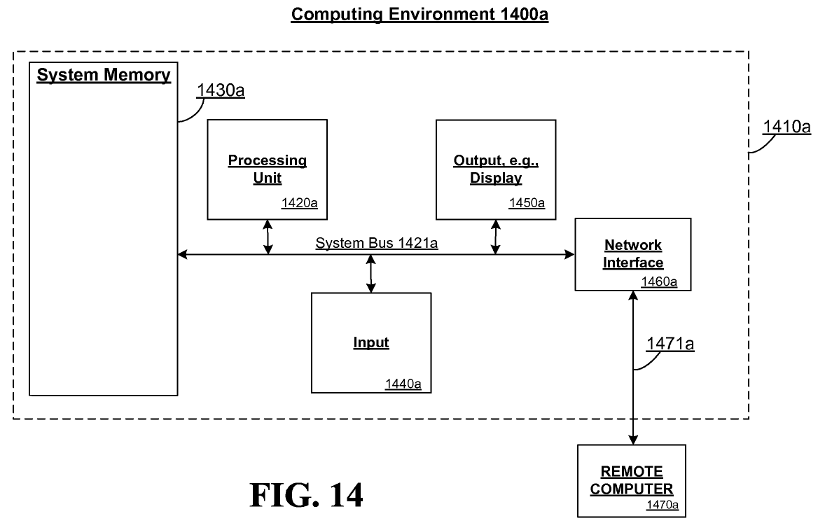

As mentioned, the invention applies to any device wherein it may be desirable to batch EDI messages. It should be understood, therefore, that handheld, portable and other computing devices and computing objects of all kinds are contemplated for use in connection with the present invention, i.e., anywhere that a device may benefit from the efficient batch membership evaluation techniques of the invention or otherwise receive, process, transmit or store EDI message data. Accordingly, the below general purpose remote computer described below in FIG. 14 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 14 thus illustrates an example of a suitable computing system environment 1400a in which the invention may be implemented, although as made clear above, the computing system environment 1400a is only one example of a suitable computing environment for a media device and is not intended to suggest any limitation as to the scope of use or functionality of the invention. Neither should the computing environment 1400a be interpreted as having any dependency or requirement relating to any one or combination of components illustrated in the exemplary operating environment 1400a.

With reference to FIG. 14, an exemplary remote device for implementing the invention includes a general purpose computing device in the form of a computer 1410a. Components of computer 1410a may include, but are not limited to, a processing unit 1420a, a system memory 1430a, and a system bus 1421a that couples various system components including the system memory to the processing unit 1420a. The system bus 1421a may be any of several types of bus structures including a memory bus or memory controller, a peripheral bus, and a local bus using any of a variety of bus architectures.

Computer 1410a typically includes a variety of computer readable media. Computer readable media can be any available media that can be accessed by computer 1410a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1410a. Communication media typically embodies computer readable instructions, data structures, program modules or other data in a modulated data signal such as a carrier wave or other transport mechanism and includes any information delivery media.

The system memory 1430a may include computer storage media in the form of volatile and/or nonvolatile memory such as read only memory (ROM) and/or random access memory (RAM). A basic input/output system (BIOS), containing the basic routines that help to transfer information between elements within computer 1410a, such as during start-up, may be stored in memory 1430a. Memory 1430a typically also contains data and/or program modules that are immediately accessible to and/or presently being operated on by processing unit 1420a. By way of example, and not limitation, memory 1430a may also include an operating system, application programs, other program modules, and program data.

The computer 1410a may also include other removable/non-removable, volatile/nonvolatile computer storage media. For example, computer 1410a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1421a through a non-removable memory interface such as an interface, and a magnetic disk drive or optical disk drive is typically connected to the system bus 1421a by a removable memory interface, such as an interface.

A user may enter commands and information into the computer 1410a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1420a through user input 1440a and associated interface(s) that are coupled to the system bus 1421a, but may be connected by other interface and bus structures, such as a parallel port, game port or a universal serial bus (USB). A graphics subsystem may also be connected to the system bus 1421a. A monitor or other type of display device is also connected to the system bus 1421a via an interface, such as output interface 1450a, which may in turn communicate with video memory. In addition to a monitor, computers may also include other peripheral output devices such as speakers and a printer, which may be connected through output interface 1450a.

The computer 1410a may operate in a networked or distributed environment using logical connections to one or more other remote computers, such as remote computer 1470a, which may in turn have media capabilities different from device 1410a. The remote computer 1470a may be a personal computer, a server, a router, a network PC, a peer device or other common network node, or any other remote media consumption or transmission device, and may include any or all of the elements described above relative to the computer 1410a. The logical connections depicted in FIG. 14 include a network 1471a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1410a is connected to the LAN 1471a through a network interface or adapter. When used in a WAN networking environment, the computer 1410a typically includes a communications component, such as a modem, or other means for establishing communications over the WAN, such as the Internet. A communications component, such as a modem, which may be internal or external, may be connected to the system bus 1421a via the user input interface of input 1440a, or other appropriate mechanism. In a networked environment, program modules depicted relative to the computer 1410a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for batching in accordance with the invention may be supported at run-time, and supported in or accessed via all of the languages and services enabled by managed code, such as .NET code, and in other distributed computing frameworks as well.

There are multiple ways of implementing the present invention, e.g., an appropriate API, tool kit, driver code, operating system, control, standalone or downloadable software object, etc. which enables applications and services to use the systems and methods for efficiently evaluating batch membership of EDI transaction sets in accordance with the invention. The invention contemplates the use of the invention from the standpoint of an API (or other software object), as well as from a software or hardware object that receives any EDI or dictionary data structures in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to efficiently batch EDI documents based on certain criteria per partner. For instance, the batching techniques of the invention may be applied to the operating system of a computing device, provided as a separate object on the device, as part of another object, as a reusable control, as a server object, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the batching processes of the present invention, e.g., through the use of a server object, a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product” or like terms) where used herein is intended to encompass a computer program accessible from any computer-readable device, carrier, or media. For example, computer readable media can include but are not limited to magnetic storage devices (e.g., hard disk, floppy disk, magnetic strips . . . optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 5, 6 and 7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular data formats, the invention is not so limited, but rather may be implemented in any format that represents structured information of any EDI standard to provide methods for efficiently evaluating batch membership of EDI messages. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for evaluating electronic data interchange (EDI) messages for membership to at least one batch of a plurality of batches defined by batch criteria information, including:
receiving at least one EDI message;
evaluating at least one property of the at least one EDI message against at least one in-memory data structure generated based on the batch criteria information; and
based on the result of said evaluating, determining to which at least one batch of the plurality of batches said at least one EDI message belongs.

2. The method of claim 1, further including:
marking the at least one EDI message with metadata information representing the at least one batch of the plurality of batches to which the at least one EDI message belongs.

3. The method of claim 1, further including:
generating the at least one in-memory data structure based on the batch criteria information.

4. The method of claim 1, further including:
generating at least one in-memory data structure based on at least one filter expression defined per trading partner.

5. The method of claim 1, further including:
generating at least one in-memory data structure based on at least one filter expression representing the batch criteria information, including at least in-memory data structure that is specific to one or more of the Boolean operators.

6. The method of claim 5, further including:
wherein said generating includes generating an index for the Equality and Exists operators that is indexed according to property value.

7. The method of claim 5, further including:
wherein said generating includes generating a sorted list for the greater than, greater than or equal to, less than, and the less than or equal to logical operators sorted according to range of possible values for a property.

8. The method of claim 5, further including:
wherein said generating includes generating an array list for the inequality operator.

9. The method of claim 1, further comprising:
based on the result of said determining, batching the at least one EDI message to the at least one batch determined for said at least one EDI message.

10. A computer readable medium comprising computer executable instructions for performing the method of claim 1.

11. A computing device comprising means for performing the method of claim 1.

12. A server object that interfaces to one or more electronic data interchange (EDI) trading partners for transmitting and receiving EDI messages, including:
a batching component that generates at least one auxiliary data structure based on batch criteria information that defines a plurality of batches and determines whether any EDI message received by the batching component belongs in at least one batch of the plurality of batches defined by batch criteria information; and
a transmission component that generates at least one interchange for the at least one batch defined by the batching component and transmits the at least one interchange to the trading partners associated with the at least one interchange.

13. The server object of claim 12, wherein the batch criteria information is updated at run-time.

14. The server object of claim 12, wherein the batching component generates the at least one auxiliary data structure taking into account commonalities of structure among batch criteria information for different parties.

15. The server object of claim 12, wherein the batching component generates a hash table for the Equality operator.

16. The server object of claim 12, wherein the batching component generates an index by name of trading partner.

17. The server object of claim 12, wherein the batching component generates a plurality of auxiliary data structures based on the batch criteria information, one for each of the Boolean operators

18. A computing subsystem of an electronic data interchange (EDI) communications system for transmitting and receiving EDI messages, including:
a batch definition subsystem that defines a plurality of batches for EDI messages using filter expressions that define the plurality of batches on a per party basis; and
a batch membership evaluation subsystem that receives the filter expressions and determines whether any EDI message received by the batch membership evaluation subsystem meets the criteria for at least one batch of the plurality of batches defined by filter expressions.

19. The computing subsystem of claim 18, further comprising:
a transmission component that generates at least one interchange for the at least one batch defined by the batch membership evaluation subsystem and transmits the at least one interchange to the parties associated with the at least one interchange.

20. The computing subsystem of claim 18, wherein the batch membership evaluation subsystem constructs at least one in-memory data structure used during evaluation of EDI messages for batch membership, whereby the at least one in-memory data structures result in a more efficient evaluation due to at least one commonality across the filter expressions.
